(19) United States
(12) Patent Application Publication
(10) Pub. No.: US 2026/0087671 A1
(43) Pub. Date: Mar. 26, 2026

(54) CAMERA CALIBRATION METHOD BASED ON INTEGRATED DYNAMIC DISPERSION-ENHANCED PARTICLE SWARM OPTIMIZATION ALGORITHM

(71) Applicants: Guilin University of Technology, Guilin (CN); Guilin University Of Aerospace Technology, Guilin (CN); Guilin Urban Planning&Design Institute, Guilin (CN); Guilin Saipu Electronic Technology Co., Ltd, Guilin (CN)

(72) Inventors: Xiaoping Yang, Guilin (CN); Longfei Nie, Guilin (CN); Zhehong Li, Guilin (CN); Xiaoxia Li, Guilin (CN); Yaolan Niu, Guilin (CN); Lieping Zhang, Guilin (CN); Guanghui Liu, Guilin (CN)

(21) Appl. No.: 19/324,147

(22) Filed: Sep. 10, 2025

(30) Foreign Application Priority Data
Sep. 20, 2024 (CN) 202411316562.7

(51) Int. Cl. G06T 7/80; G06N 3/006

(52) U.S. Cl. CPC G06T 7/80; G06N 3/006; G06T 2207/20004; G06T 2207/20081

(57) ABSTRACT

A camera calibration method based on an integrated dynamic dispersion-enhanced particle swarm optimization algorithm includes: acquiring multiple images of a calibration board of different angles and converting them into grayscale images, detecting Harris corner points, and solving sub-pixel coordinate; estimating, by using the sub-pixel coordinates and a distortion camera model, initial values of camera intrinsic parameters through Zhang's camera calibration method; calibrating the camera intrinsic parameters, and calculating fitness values of particles; determining whether iteration termination condition is met, whether the fitness values of the particles have reached a convergence condition, and whether algorithm is trapped in a local optimum, to thereby determine whether a maximum number of iterations is reached or a specific fitness threshold is met; and outputting camera parameters corresponding to a global optimal solution of the particles when the maximum number of iterations is reached or the specific fitness threshold is met.

### CROSS-REFERENCE TO RELATED APPLICATION

This application claims priority to Chinese Patent Application No. 202411316562.7, filed on Sep. 20, 2024, which is herein incorporated by reference in its entirety.

### TECHNICAL FIELD

The disclosure relates to the technical field of sensor intrinsic parameter calibration, and more particularly to a camera calibration method based on an integrated dynamic dispersion-enhanced particle swarm optimization (IDDE-PSO) algorithm.

### BACKGROUND

Sensor calibration is a key technology for high-precision visual measurement and a fundamental requirement for autonomous driving. Calibration in the art can be summarized into two parts of error calibration and position calibration. The error calibration corrects sensor errors to obtain intrinsic parameter information. The position calibration obtains a relative positional relationship between sensors to obtain extrinsic parameter information. Camera calibration establishes a mapping transformation relationship between image pixel position coordinates and scene point positions by solving camera intrinsic and extrinsic parameters. In a process of stereo vision-based three-dimensional (3D) reconstruction and depth information acquisition, the camera calibration is an indispensable key step for obtaining 3D spatial information from two-dimensional (2D) image data. Accuracy of calibration results and robustness of a calibration algorithm of the camera calibration directly affect precision of subsequent measurement tasks. With a development of camera calibration technology, camera calibration methods widely accepted by researchers and scholars and applied in practice mainly include a direct linear transformation (DLT) method, Tsai's two-step method, and Zhang's planar calibration method (also referred to as Zhang's camera calibration method). However, the direct linear transformation method does not consider distortion problems in camera imaging; the Tsai's two-step method has a cumbersome solving process and is prone to being trapped in local optima when initial values are poor; and the Zhang's planar calibration method overcomes excessive dependence on high-precision equipment for calibration but still has limitations on the accuracy of calibration results.

In recent years, Chinese and foreign scholars have continued to conduct research and make progress in the field of camera calibration technology. The camera calibration methods in the art are broadly classified into two categories. One category refers to nonlinear calibration methods based on Zhang's planar calibration method and combined with MATLAB and OpenCV calibration toolboxes to optimize multi-objective and nonlinear calibration parameters by using machine learning methods and intelligent optimization algorithms. The nonlinear calibration methods have advantages of strong adaptability and high calibration accuracy for single camera calibration, but suffer from cumbersome calibration process and time-consuming. Another category refers to implicit calibration methods, which bypass the camera imaging model and directly establish a mapping relationship between 2D image pixel coordinates and 3D world coordinates, such as an explanatory calibration method that simplifies a calibration process based on powerful self-learning and nonlinear mapping abilities of artificial neural networks. However, accuracy of calibration results and convergence speed of the explanatory calibration method are easily affected by long iteration time, slow convergence speed, and poor generalization ability of a back propagation (BP) neural network, thus cannot meet practical requirements of vehicle-mounted calibration systems for high efficiency and high precision. Calibration models based on deep learning need to learn the camera intrinsic and extrinsic parameters from a large amount of data and collect a large amount of data for training and are sensitive to data quality.

### SUMMARY

Based on this, the disclosure aims to provide a camera calibration method based on an IDDE-PSO algorithm. By introducing the IDDE-PSO algorithm, it is easier to find a global optimal solution in a complex search space, thereby improving efficiency and accuracy of camera calibration.

To achieve the aforementioned objectives, the disclosure provides the following technical solutions.

The camera calibration method based on the IDDE-PSO algorithm provided by an embodiment of the disclosure includes the following steps:
S1, acquiring multiple images of a calibration board of different angles, converting the multiple images of the calibration board into grayscale images, detecting Harris corner points of the grayscale images, and solving sub-pixel coordinates;
S2, estimating, by using the sub-pixel coordinates and a distortion camera model, initial values X₀ of camera intrinsic parameters through Zhang's camera calibration method;
S3, initializing parameters of the IDDE-PSO algorithm, calibrating the camera intrinsic parameters based on the initial values of the camera intrinsic parameters, and calculating fitness values of particles;
S4, determining whether the fitness values of the particles have reached a convergence condition; when the fitness values of the particles have not reached the convergence condition, performing adaptive nonlinear adjustment on an inertia parameter, adaptively adjusting learning factors by using sine and cosine variations, iteratively updating velocities and positions of the particles, continuously updating individual optimal positions and global optimal positions of the particles by using a greedy selection algorithm, optimizing the camera intrinsic parameters by using the IDDE-PSO algorithm, and determining whether a maximum number of iterations is reached or a specific fitness threshold is met;
S5, determining whether the IDDE-PSO algorithm is trapped in a local optimum when the fitness values of the particles in step S4 have reached the convergence condition; when the IDDE-PSO algorithm is trapped in the local optimum, introducing a Cauchy perturbation-based particle swarm optimization algorithm, updating the individual optimal positions of the particles and re-evaluating the fitness values of the particles, continuously updating the individual optimal positions and the global optimal positions of the particles by using the greedy selection algorithm, optimizing the camera intrinsic parameters by using the IDDE-PSO algorithm, and determining whether the maximum number of iterations is reached or the specific fitness threshold is met; when the IDDE-PSO algorithm is not trapped in the local optimum, directly determining whether the maximum number of iterations is reached or the specific fitness threshold is met; and
S6, outputting camera parameters corresponding to a global optimal solution of the particles when the maximum number of iterations is reached or the specific fitness threshold is met; returning to execute steps S3 to S5 until the maximum number of iterations is reached or the specific fitness threshold is met when the maximum number of iterations is not reached and the specific fitness threshold is not met.

In an embodiment, in the step S2, the initial values X₀ of the camera intrinsic parameters estimated through the Zhang's camera calibration method are specifically as follows:

$${X}_{0} = ( α , β , γ , {u}_{0} , {v}_{0} , {k}_{1} , {k}_{2} , {p}_{1} , {p}_{2} , {k}_{3} ) ;$$

where, (u₀,v₀) is a principal point coordinate of image; (α,β) is a ratio of a camera focal length to a physical size of a unit pixel; γ represents a skew factor, k₁, k₂, and k₃ are radial distortion parameters, and p₁ and p₂ are tangential distortion parameters.

In an embodiment, the parameters of the IDDE-PSO algorithm initialized in step S3 include a population size N, the maximum number of iterations T, a stagnation threshold Sₜ=15, an inertia weight w, and maximum values and minimum values of the learning factors c₁ and c₂.

In an embodiment, in step S3, the calculating fitness values of particles specifically includes the following steps:
calculating a minimum average reprojection error X_{best} of M corner points in each of the multiple images of the calibration board, and taking the minimum average reprojection error X_{best} as an optimization objective;
taking current position of each of the particles as the individual optimal position of the particle; and
taking the fitness value of current one of the particles as an individual optimal solution of the current one of the particles.

In an embodiment, the calculating a minimum average reprojection error X_{best} of M corner points in each of the multiple images of the calibration board is specifically as follows:
expressing an average reprojection error function of each of the multiple images of the calibration board as follows:

$$f ( X ) = \frac{1}{M} \sqrt{{\sum }_{i = 1}^{M} {( K ( X ) [ R T ] {P}_{i} - {q}_{i} )}^{2}} ,$$

where, M is a number of corner points of the calibration board, K(X)[R T]Pᵢ is a coordinate of a reprojection point obtained by projecting a coordinate point Pᵢ in a world coordinate system corresponding to an i-th target point back onto an image plane through a nonlinear camera imaging model; and qᵢ is a sub-pixel corner point coordinate actually detected at an i-th corner point; and
calculating the minimum average reprojection error X_{best} of the M corner points in each of the multiple images of the calibration board as follows:

$${X}_{best} = {arg min}_{x} ( \frac{1}{M} \sqrt{{\sum }_{i = 1}^{M} {( K ( X ) [ R T ] {P}_{i} - {q}_{i} )}^{2}} ) .$$

In an embodiment, in step S5, the Cauchy perturbation-based particle swarm optimization algorithm is specifically as follows:

$$\{ \begin{matrix}{v}_{id}^{t + 1} = {w}_{id}^{t} {v}_{id}^{t} + {c}_{1} {r}_{1} ( {p}_{id}^{t} - {X}_{id}^{t} + {r}_{3} {Cauchy}_{i}^{t} ) + {c}_{2} {r}_{2} ( {g}_{d} - {X}_{i d}^{t} ) \\ {X}_{id}^{t + 1} = {X}_{i d}^{t} + {v}_{i d}^{t + 1}\end{matrix} ;$$

$$where {Cauchy}_{i}^{t} = {r}_{4} Cauchy ( u , σ )$$

represents a Cauchy perturbation generated by a particle i in a t-th iteration; u represents a mean value, r₃ and r₄ are random numbers in a range of [0, 1];

$$σ = {σ}_{0} \frac{T - t}{T}$$

represents a variance; σ₀ represents an initial standard deviation; t represents a current number of iterations; and T represents the maximum number of iterations

In an embodiment, in step S4, the performing adaptive nonlinear adjustment on an inertia parameter is realized as follows:

$${w}_{i}^{t} = \{ \begin{matrix}{w}_{min} - ( {w}_{max} - {w}_{min} ) \frac{f ( {X}_{i}^{t} ) - {f}_{min}^{t}}{{f}_{average}^{t} - {f}_{min}^{t}} , f ( {X}_{i}^{t} ) \leq {f}_{average}^{t} \\ {w}_{max} , f ( {X}_{i}^{t} ) > {f}_{average}^{t}\end{matrix}$$

$${f}_{average}^{t} = \frac{{\sum }_{i = 1}^{n} f ( {X}_{i}^{t} )}{n}$$

$${f}_{min}^{t} = min \{ f ( {X}_{1}^{t} ) , f ( {X}_{2}^{t} ) , … , f ( {X}_{n}^{t} ) \}$$

where, wₘₐₓ=0.9 represents a maximum value of the inertial parameter; wₘᵢₙ=0.4 represents a minimum value of the inertial parameter;

$$f ( {X}_{i}^{t} )$$

represents the fitness value of the current one of the particles in a t-th iteration;

$${f}_{average}^{t}$$

represents an average value of current fitness values of all the particles; and

$${f}_{min}^{t}$$

represents a minimum value of the current fitness values of all the particles.

In an embodiment, in step S4, the adaptively adjusting learning factors by using sine and cosine variations is realized as follows:

$${c}_{1} = {c}_{1 \_ max} + ( {c}_{1 \_ max} - {c}_{1 \_ min} ) cos ( π * \frac{t}{T} )$$

$${c}_{2} = {c}_{2 \_ max} + ( {c}_{2 \_ max} - {c}_{2 \_ min} ) sin ( π * \frac{t}{T} )$$

where, c_{1_max}=1.5 and c_{1_min}=1 are upper and lower limit values of a learning factor c₁, respectively; c_{2_max}=1.5 and c_{2_min}=1 are upper and lower limit values of a learning factor c₂, respectively; t represents the current number of iterations; and T represents a total number of iterations

In an embodiment, in step S4, the iteratively updating velocities and positions of the particles specifically includes the following steps:
taking positions corresponding to all the particles as global optimal positions;
comparing a current state of each of the particles to a historical global optimal state of the particle, screening by minimizing the average reprojection error function, and taking the current fitness value of the particle and a position of the particle corresponding thereto as an updated individual optimal value of the particle when the current fitness value of the particle is smaller than the individual optimal value of the particle; and
calculating a minimum value of individual optimal values of all the particles; comparing the minimum value with a global optimal value; and when the minimum value is smaller than the global optimal value, namely a particle state is better than a global optimal state, updating the global optimal state.

In an embodiment, in step S5, the updating the individual optimal positions of the particles and re-evaluating the fitness values of the particles is realized as follows:

$${v}_{i d}^{t + 1} = w {v}_{i d}^{t} + {c}_{1} {r}_{1} ( {p}_{i d}^{t} - {X}_{i d}^{t} ) + {c}_{2} {r}_{2} ( {g}_{d} - {X}_{i d}^{t} )$$

$${x}_{i d}^{t + 1} = {x}_{i d}^{t} + {v}_{i d}^{t + 1} , d = 1 , 2 , … , D$$

$$where , {v}_{i d}^{t}$$

represents the velocity of a particle; a superscript t represents the current number of iterations; a subscript i represents an index of the particle; a superscript d represents a dimension of the particle; X represents a position of an i-th particle; p represents the individual optimal position P_{best} of the i-th particle; g represents the global optimal value searched by a particle swarm; w represents the inertia weight and is configured to balance global search and local development capabilities; c₁ and c₂ are acceleration coefficients, namely the learning factors, and r₁ and r₂ are random numbers in a range of [0, 1].

In an embodiment, the camera calibration method based on the IDDE-PSO algorithm further includes applying the camara parameters output in step S6 in image distortion correction and 3D reconstruction.

Based on the embodiment of the disclosure, the disclosure provides a simple camera calibration method, which extracts corner points from an original checkerboard image for further sub-pixel refinement. The camera calibration method provided by the disclosure improves a camera imaging model, and at the same time, takes into account a functional relationship between the camera intrinsic parameters and distortion coefficients and fits them together, resulting in a more accurate camera imaging model. The camera calibration method provided by the disclosure improves search efficiency, global search capability, and local development capability of an algorithm by using an inertia weight nonlinear adaptive adjustment mechanism, a dynamic self-adjusting strategy with the sine and cosine variations, and an improved particle swarm optimization algorithm with a dispersion mechanism. The camera calibration method based on the IDDE-PSO algorithm provided by the disclosure has superior optimization capability compared to a Levenberg-Marquardt method used in a nonlinear optimization process of camera calibration. Therefore, the technical solution of the disclosure has advantages of high search efficiency, fast convergence speed, reduced risk of being trapped in the local optimum, and accurate and reliable calibration results when solving nonlinear problems of camera calibration optimization.

### BRIEF DESCRIPTION OF DRAWINGS

In order to more clearly describe technical solutions of embodiments of the disclosure or technical solutions in the art, attached drawings used in description of the embodiments or the related art will be briefly introduced below. Apparently, the attached drawings described below are merely embodiments of the disclosure. For those skilled in the art, other attached drawings can also be obtained based on the attached drawings provided in the disclosure without creative labor.

A camera calibration method based on an IDDE-PSO algorithm provided by the disclosure will be further described as follows with reference to the attached drawings.

FIG. 1 illustrates a flowchart of the camera calibration method based on the IDDE-PSO algorithm according to an embodiment of the disclosure.

FIG. 2 illustrates a schematic diagram of a calibration board.

### DETAILED DESCRIPTION OF EMBODIMENTS

Implementation of embodiments of the disclosure will be further described in detail with reference to attached drawings and the embodiments of the disclosure. Embodiments described below are merely used to illustrate the disclosure, rather than limit a scope of protection of the disclosure.

To better understand objectives, structures, and functions of the disclosure, the disclosure will be further described in detail with reference to the attached drawings.

In research of camera calibration methods in the art, corner detection technology and application of intelligent algorithms to seek an optimal solution for nonlinear optimization of camera models are key technical points in the field of camera calibration to simplify calibration models, improve accuracy of calibration results, and enhance algorithm robustness. Therefore, the disclosure uses a suitable optimization algorithm to improve the accuracy of the calibration results while ensuring a calibration speed and stability of the calibration results, which is key to achieving an ideal camera calibration outcome.

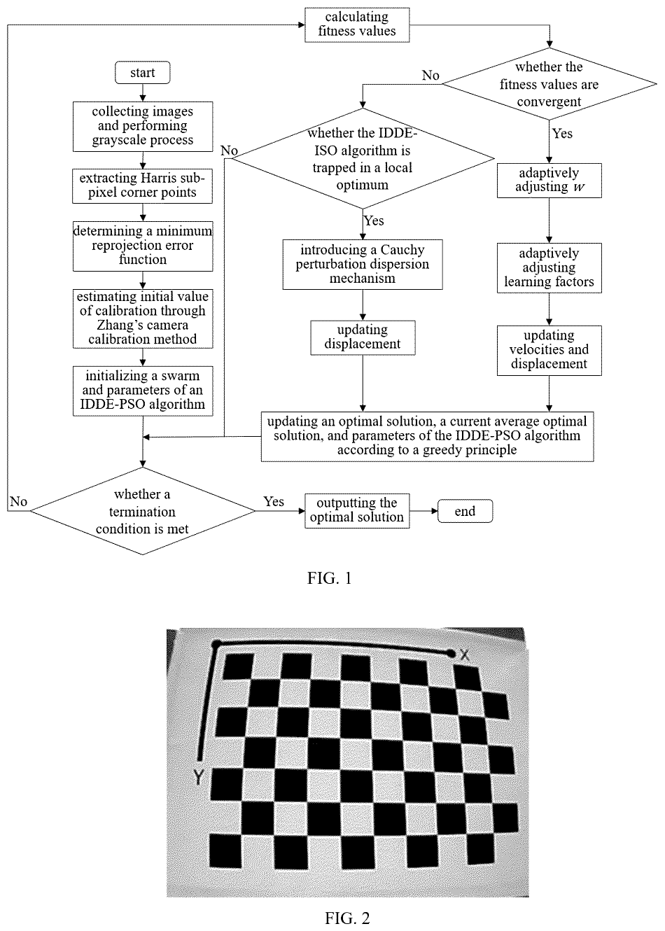

As illustrated in FIG. 1, the disclosure provides a camera calibration method based on an IDDE-PSO algorithm, including the following steps S1 through S6.

S1, multiple images of a calibration board of different angles are acquired. The multiple images of the calibration board are converted into grayscale images. Harris corner points of the grayscale images are detected. Sub-pixel coordinates are solved.

S2, initial values X₀ of camera intrinsic parameters are estimated by using the sub-pixel coordinates and a distortion camera model through Zhang's camera calibration method.

S3, parameters of the IDDE-PSO algorithm are initialized. The camera intrinsic parameters are calibrated based on the initial values of the camera intrinsic parameters. Fitness values of particles are calculated.

S4, whether the fitness values of the particles have reached a convergence condition is determined. When the fitness values of the particles have not reached the convergence condition, an inertial parameter is performed with adaptive nonlinear adjustment, learning factors are adaptively adjusted by using sine and cosine variations, velocities and positions of the particles are iteratively updated, individual optimal positions and global optimal positions of the particles are continuously updated by using a greedy selection algorithm, the camera intrinsic parameters are optimized by using the IDDE-PSO algorithm, and whether a maximum number of iterations is reached or a specific fitness threshold is met is determined.

S5, when the fitness values of the particles in step S4 have reached the convergence condition, whether the IDDE-PSO algorithm is trapped in a local optimum is determined. When the IDDE-PSO algorithm is trapped in the local optimum, a Cauchy perturbation-based particle swarm optimization algorithm is introduced, the individual optimal positions of the particles are updated, the fitness values of the particles are re-evaluated, the individual optimal positions and the global optimal positions of the particles are continuously updated by using the greedy selection algorithm, the camera intrinsic parameters are optimized by using the IDDE-PSO algorithm, and whether the maximum number of iterations is reached or the specific fitness threshold is met is determined. When the IDDE-PSO algorithm is not trapped in the local optimum, whether the maximum number of iterations is reached or the specific fitness threshold is met is directly determined.

It should be noted that the IDDE-PSO algorithm is improved from a standard particle swarm optimization (PSO) algorithm by introducing mutation, crossover, and selection operations of difference evaluation (DE) on a basis of the standard PSO algorithm. An optimization method includes the following steps. Firstly, the multiple images of the calibration board of different angles are photographed, and the multiple images of the calibration board are converted into the grayscale image, and the Harris corner points of the grayscale images are detected to obtain the sub-pixel coordinates. Subsequently, the camera intrinsic parameters are initially estimated by using the sub-pixel coordinates and the distortion camera mode through Zhang's camera calibration method, and then the camera intrinsic parameters initially computed are input into the IDDE-PSO algorithm to finely optimize the camera intrinsic parameters. The IDDE-PSO algorithm iteratively updates the velocities and the positions of the particles in a swarm, incorporates a nonlinear adaptive strategy to adjust the inertia parameter and dynamically self-adjust the learning factors, and takes a minimum average reprojection error as an optimization objective. During an optimization process, the IDDE-PSO algorithm introduces a local optimum detection and dispersion mechanism to avoid being trapped in the local optimum. Finally, when the iterations of the IDDE-PSO algorithm terminate, the camera intrinsic parameters represented by a global optimal particle are output as the calibration results, thereby achieving high-precision calibration of the camera intrinsic parameters.

S6, when the maximum number of iterations is reached or the specific fitness threshold is met, camera parameters corresponding to a global optimal solution of the particles are outputted. When the maximum number of iterations is not reached and the specific fitness threshold is not met, the IDDE-PSO algorithm returns to execute steps S3 to S5 until the maximum number of iterations is reached or the specific fitness threshold is met.

It should be noted that an average reprojection error function is taken as a fitness function for the IDDE-PSO algorithm, and the camera intrinsic parameters are optimized based on the IDDE-PSO algorithm. PSO algorithm, inspired by foraging behavior of birds in nature, aims to find a global optimal solution. The PSO algorithm is featured by simplicity, efficiency, and few parameter settings; therefore, it is widely used to solve multidimensional optimization problems. Each of the particles in the swarm is constructed by a D-dimensional vector, namely Xᵢ=[xᵢ₁, xᵢ₂, . . . , x_{iD}], i=1, 2, . . . , N; N represents a population size, directly affecting search capability of the PSO algorithm and computational load required to locate an optimal solution. The individual optimal position P_{best} of one of the particles in a search space is iteratively updated by a velocity vector and converges toward a global optimal region G_{best}.

The individual optimal position P_{best} and the global optimal region G_{best} are continuously updated by using the greedy selection algorithm. This mechanism enables a particle swarm to quickly converge to a vicinity of the optimal solution and effectively avoid being trapped in the local optimum.

In step S2, the initial values X₀ of the camera intrinsic parameters estimated by through the Zhang's camera calibration method are specifically as follow:

$${X}_{0} = ( α , β , γ , {u}_{0} , {v}_{0} , {k}_{1} , {k}_{2} , {p}_{1} , {p}_{2} , {k}_{3} ) ;$$

where (u₀,v₀) is a principal point coordinate of image; (α,β) is a ratio of a camera focal length to a physical size of a unit pixel; γ represents a skew factor, k₁, k₂, and k₃ are radial distortion parameters, and p₁ and p₂ are tangential distortion parameters.

The parameters of the IDDE-PSO algorithm initialized in step S3 include the population size N, the maximum number of iterations T, a stagnation threshold Sₜ=15, an inertia weight w, and maximum values and minimum values of the learning factors c₁ and c₂.

In step S3, the fitness values of the particles are calculated through the following sub-steps 3-1 through 3-3.

Sub-step 3-1, a minimum average reprojection error X_{best} of M corner points in each of the multiple images of the calibration board is calculated, and the minimum average reprojection error X_{best} is taken as an optimization objective.

Sub-step 3-2, current position of each of the particles is taken as the individual optimal position of the particle.

Sub-step 3-3, the fitness value of current one of the particles is taken as an individual optimal solution of the current one of the particles.

It should be noted that the individual optimal solution is a fitness value of the individual optimal position, and the fitness value (optimization objective) is a function of positions.

A minimum value

$${f}_{min}^{t}$$

of the fitness values of all the particles is taken as a global optimal solution X_{best}.

It should be noted that the fitness values of the particles are calculated through the following steps. f(X₀) is calculated, and the minimum average reprojection error X_{best} of the M corner points is calculated and taken as the optimization objective. The current position of each of the particles is taken as the individual optimal position pa of the particle, and the fitness value of the current one of the particles is taken as the individual optimal solution of the current one of the particles. The minimum value

$${f}_{min}^{t}$$

of the fitness values of all the particles is taken as the global optimal solution X_{best}, and a particle position corresponding to the minimum value fₘᵢₙ^{t} is taken as a global optimal position ga. When initializing the swarm, an initial individual optimal position p_{d}=X₀, and the global optimal position ga is an initial value obtained through the Zhang's camera calibration method with sub-pixel optimization, and particles obtained are 0th generation particles.

The minimum average reprojection error X_{best} of the M corner points in each of the multiple images of the calibration board is calculated specifically as follows:
expressing the average reprojection error function of each of the multiple images of the calibration board as follows:

$$f ( X ) = \frac{1}{M} \sqrt{{\sum }_{i = 1}^{M} {( K ( X ) [ R T ] {P}_{i} - {q}_{i} )}^{2}} ; \qquad formula ( 1 )$$

where, M is a number of corner points of the calibration board, K(X)[R T]Pᵢ is a coordinate of a reprojection point obtained by projecting a coordinate point Pᵢ in a world coordinate system corresponding to an i-th target point back onto an image plane through a nonlinear camera imaging model; and qᵢ is a sub-pixel corner point coordinate actually detected at an i-th corner point; and
calculating the minimum average reprojection error X_{best} of the M corner points in each of the multiple images of the calibration board as follows:

$${X}_{best} = {arg min}_{x} ( \frac{1}{M} \sqrt{{\sum }_{i = 1}^{M} {( K ( X ) [ R T ] {P}_{i} - {q}_{i} )}^{2}} ) . \qquad formula ( 2 )$$

In step S5, the Cauchy perturbation-based particle swarm optimization algorithm is specifically as follows:

$$\{ \begin{matrix}{v}_{i d}^{t + 1} = {w}_{i d}^{t} {v}_{i d}^{t} + {c}_{1} {r}_{1} ( {p}_{i d}^{t} - {X}_{i d}^{t} + {r}_{3} {Cauchy}_{i}^{t} ) + {c}_{2} {r}_{2} ( {g}_{d} - {X}_{i d}^{t} ) \\ {X}_{i d}^{t + 1} = {X}_{i d}^{t} + {v}_{i d}^{t + 1}\end{matrix} \qquad formula ( 8 )$$

$$where {Cauchy}_{i}^{t} = {r}_{4} Cauchy ( u , σ )$$

represents a Cauchy perturbation generated by a particle i in a t-th iteration; u represents an average value, r₃ and r₄ are random numbers in a range of [0,1];

$$σ = {σ}_{0} \frac{T - t}{T}$$

represents a variance; σ₀ represents an initial standard deviation; t represents a current number of iterations; and T represents the maximum number of iterations.

In step S4, the inertia parameter is performed with adaptive nonlinear adjustment according to the following formulas:

$${w}_{i}^{t} = \{ \begin{matrix}{w}_{min} - ( {w}_{max} - {w}_{min} ) \frac{f ( {X}_{i}^{t} ) - {f}_{min}^{t} )}{{f}_{average}^{t} - {f}_{min}^{t}} , f ( {X}_{i}^{t} ) \leq {f}_{average}^{t} \\ {w}_{max} , f ( {X}_{i}^{t} ) > {f}_{average}^{t}\end{matrix} \qquad formula ( 4 )$$

$${f}_{a v e r a g e}^{t} = \frac{{\sum }_{i = 1}^{n} f ( {x}_{i}^{t} )}{n} \qquad formula ( 5 )$$

$${f}_{min}^{t} = min \{ f ( {X}_{1}^{t} ) , f ( {X}_{2}^{t} ) , … , f ( {X}_{n}^{t} ) \} ; \qquad formula ( 6 )$$

where, wₘₐₓ=0.9 represents a maximum value of the inertial parameter; wₘᵢₙ=0.4 represents a minimum value of the inertial parameter;

$$f ( {X}_{i}^{t} )$$

represents the fitness value of the current one of the particles in a t-th iteration;

$${f}_{average}^{t}$$

represents an average value of current fitness values of all the particles; and

$${f}_{min}^{t}$$

represents a minimum value of the current fitness values of all the particles.

The learning factors are adjusted according to the following formula:

$${c}_{1} = {c}_{1 \_ max} + ( {c}_{1 \_ max} - {c}_{1 \_ min} ) cos ( π * \frac{t}{T} ) \qquad formula ( 7 )$$

$${c}_{2} = {c}_{2 \_ max} + ( {c}_{2 \_ max} - {c}_{2 \_ min} ) sin ( π * \frac{t}{T} )$$

where, c_{1_max}=1.5 and c_{1_min}=1 are upper and lower limit values of the learning factor c₁, respectively; c_{2_max}=1.5 and c_{2_min}=1 are upper and lower limit values of the learning factor c₂, respectively; t represents the current number of iterations; and T represents a total number of iterations.

It should be noted that the learning factors can adaptively adjust with an iteration process, thereby improving search efficiency of the IDDE-PSO algorithm.

In step S4, the velocities and the positions of the particles are iteratively updated through the following sub-step 4-1 through 4-3.

Sub-step 4-1, positions corresponding to all the particles are taken as global optimal positions g_{d}.

Sub-step 4-2, a current state of each of the particles is compared with a historical global optimal state of the particle and screened by minimizing the average reprojection error function. The current fitness value of the particle and a position of the particle corresponding thereto are taken as an updated individual optimal value of the particle when the current fitness value of the particle is smaller than an individual optimal value of the particle.

It should be noted that, the individual optimal value refers to a minimum fitness value of a particle during the iteration process. When the fitness value of the particle becomes smaller after a certain iteration, the fitness value is a new individual optimal value, and an original individual optimal value will be replaced by the new individual optimal value.

Sub-step 4-3, a minimum value of individual optimal values of all the particles is calculated and compared with a global optimal value. When the minimum value is smaller than the global optimal value, namely a particle state is better than a global optimal state, the global optimal state is updated.

In step S5, the individual optimal positions of the particles are updated and the fitness values of the particles are re-evaluated according to the following formulas:

$${v}_{i d}^{t + 1} = w {v}_{i d}^{t} + {c}_{1} {r}_{1} ( {p}_{i d}^{t} - {X}_{i d}^{t} ) + {c}_{2} {r}_{2} ( {g}_{d} - {X}_{i d}^{t} ) \qquad formula ( 3 )$$

$${X}_{i d}^{t + 1} = {X}_{i d}^{t} + {v}_{i d}^{t + 1} , d = 1 , 2 , … , D$$

$$where , {v}_{i d}^{t}$$

represents the velocity of the particle; a superscript t represents the current number of iterations; a subscript i represents an index of the particle; a superscript d represents a dimension of the particle; X represents a position of an i-th particle; p represents the individual optimal position P_{best} of the i-th particle; g represents the global optimal value searched by the particle swarm; w represents the inertia weight and is configured to balance global search and local development capabilities; c₁ and c₂ are acceleration coefficients, namely the learning factors; and r₁ and r₂ are random numbers in a range of [0,1].

It should be noted that, the camera parameters X_{best}=f(g_{d}) correspond to an optimal solution. When the iterations of the IDDE-PSO algorithm terminate, the camera intrinsic parameters represented by the global optimal particle are output as optimization results.

Table 1 illustrates key steps of the IDDE-PSO algorithm

TABLE 1
Algorithm 1: IDDE-PSO algorithm

```
$Input : target function f ( X ) = \frac{1}{M} \sqrt{{\sum }_{i = 1}^{M} {( K ( X ) [ R T ] {P}_{i} - {q}_{i} )}^{2}}$
Output: g_{d}, f(g_{d})
  1. Parameters relating to the IDDE-PSO algorithm are initialized, such as, initial values
  X₀ = (α, β, γ, u₀, v₀, k₁, k₂, p₁, p₂, k₃) of the camera intrinsic parameters, fitness value
  f(X₀) of the swarm, the population size N = 200, t = 1, the maximum number of
  iteration T = 500, the stagnation threshold Sₜ = 15, the minimum value of the inertia
  weight wₘᵢₙ = 0.4, the maximum value of the inertia weight wₘₐₓ = 0.9, the upper limit
  values of the learning factors c₁_max = c₂_max = 1.5, and the lower limit values of the
  learning factors c₁_min = c₂_min = 1.
  2. p_{d} < X₀, g_{d} − X₀;
  3. s ← 0;
  4. while (t < T) or (stop criterion) do
  5.  the inertia weight is updated according to formula (4), and the learning factors are
  updated according to formula (7);
  6. the individual optimal positions p_{d} are updated according to formula (3);
  7. the fitness values of the particles are evaluated according to the target function;
  8. the average value f_{average}^{t} of the fitness values of the particles are updated according to
  formula (5);
  9. if p_{d} < g_{d} then do
  10.  if p_{d} = g_{d} then do
  11.  s + s + 1;
  12.  if s > s_{T} then do
  13.  Cauchy perturbation-based particle swarm optimization algorithm is introduced,
  and the individual optimal positions are updated according to formula (8) and the fitness
  values are re-evaluated;
  14.  a stagnation counter is reset, namely s ← 0;
  15.  end if
  16.  end if
  17.  the optimal solution and the fitness value thereof are updated, g_{d} ← p_{d};
  18.  end if
  19.  the velocities and the positions p_{d} of the particles are updated;
  20.  the global optimal positions g_{d} are updated;
  21.  t + t + 1;
  22. end while
  23. return g_{d}, f(g_{d})
```

The disclosure has the following beneficial effects.

### Corner Points Sub-Pixel Refinement

As illustrated in FIG. 2, in a black-and-white checkerboard, the corner points refer to intersection points of black and white edges of the black-and-white checkerboard. The disclosure firstly uses a Harris detector to preliminarily determine pixel level coordinates of the corner points. To further improve accuracy of the corner points, an equation is established to solve sub-pixel corner points q by using mathematical characteristics of corner points that a dot product of a vector and its orthogonal vector is zero. A specific process is to select a window of an appropriate size with an initial corner point q₀ as a center, such as (11, 11), and calculate gradient information Gᵢ of each integer coordinate point pᵢ within the window. When the integer coordinate point pᵢ is located at edges of the black-and-white checkerboard, a gradient vector Gᵢ of the integer coordinate pᵢ is orthogonal to an edge pᵢ−q, namely Gᵢ(pᵢ−q)=0. By calculating pseudo inverse, a new sub-pixel coordinate qₗ is obtained, which is expressed as follows:

$${q}_{l} = \sum {( {G}_{i}^{T} - {G}_{i} )}^{- 1} \cdot {G}_{i}^{T} {G}_{i} {p}_{i} . \qquad formula ( 9 )$$

In order to obtain more accurate sub-pixel coordinates, an iterative method is used to continuously update coordinate values. To avoid missing corner points or generating false corner points, a sub-pixel precision threshold ε is specified as a termination condition for an iteration process. When an update amount of coordinates is less than the sub-pixel precision threshold, the iteration process is terminated, and resulting sub-pixel coordinates are taken as final results:

$${‖ {q}_{t} - {q}_{t - 1} ‖}_{2} \leq ε . \qquad formula ( 10 )$$

### Sub-Pixel Refinement Experiment

The sub-pixel precision threshold ε is set to 0.0001, and average reprojection errors across all images are calculated. Results are shown in table 2. By comparing errors under different number of images, it can be seen that increasing the number of images will lead to an increase in corner point measurement errors. However, it is worth noting that after sub-pixel refinement, the errors are significantly lower than those of results without refinement. For example, an error of 20 images after refinement is reduced by 0.092 pixels, which verifies an effect of the sub-pixel refinement on improving the accuracy of the calibration results.

TABLE 2
average reprojection errors at ε = 0.0001

| Pictures/ | Error without | Error after |
|---|---|---|
| sheet | refinement/pixel | refinement/pixel |
| 5 | 0.2570 | 0.2486 |
| 10 | 0.3125 | 0.2891 |
| 15 | 0.3311 | 0.3182 |
| 20 | 0.3715 | 0.3623 |

### Comparative Experiment of Different Calibration Algorithms

20 collected images of the calibration board are selected as experimental data, of which experimental data of experiment on original images is images of the calibration board without sub-pixel corner point detection, and experimental data of experiment on original images with refinement is images of the calibration board with sub-pixel corner point detection. Zhang' refers to the Zhang's camera calibration method. Experimental results of the camera intrinsic calibration method based on the IDDE-PSO algorithm provided by the disclosure (referred to as “Ours”), in comparison with Zhang', a MATLAB toolbox, a traditional PSO calibration method, and a quantum particle swarm optimization (QPSO) method, are shown in the following table. The traditional PSO calibration method, the QPSO method and Ours use original+refined experimental results as initial data for nonlinear optimization.

TABLE 3
comparison of experimental results of different calibration algorithms

| Parameter | | Original | Original + | | | | | |
|---|---|---|---|---|---|---|---|---|
| (pixel) | | images | refined | MATLAB | Zhang' | PSO | QPSO | Ours |
| intrinsic | α | 407.6311 | 405.7851 | 406.3531 | 404.1720 | 404.0840 | 405.1643 | 404.7777 |
| parameters | β | 406.9180 | 408.5638 | 407.3980 | 404.5811 | 406.4676 | 404.2876 | 405.3223 |
| | s | −0.3830 | −0.0019 | −0.0772 | 0 | 0 | 0 | 0 |
| | u₀ | 280.0814 | 279.1751 | 278.8542 | 278.5776 | 278.5716 | 278.5943 | 278.7436 |
| | v₀ | 223.2800 | 223.1047 | 222.9143 | 221.6582 | 220.8073 | 221.6954 | 221.4545 |
| distortion | k₁ | −0.4209 | −0.4202 | −0.3896 | −0.4216 | −0.3577 | −0.4156 | −0.4218 |
| parameters | k₂ | 0.2119 | 0.2105 | 0.1372 | 0.2376 | 0.0754 | 0.2118 | 0.2376 |
| | p₁ | −0.0037 | −0.0040 | −0.0031 | — | 0.0034 | −0.0037 | −0.0030 |
| | p₂ | 0.0028 | 0.0029 | 0.0024 | — | 0.0038 | 0.0027 | 0.0016 |
| | k₃ | −0.0557 | −0.0050 | — | — | −0.0550 | — | −0.0079 |

| | | | | | | | |
|---|---|---|---|---|---|---|---|
| average | 0.3715 | 0.3623 | 0.3505 | 0.3610 | 0.3281 | 0.3427 | 0.1623 |
| reprojection | | | | | | | |
| error | | | | | | | |

It can be seen from the experimental results shown in table 3, the camera calibration method provided by the disclosure not only effectively calibrates both intrinsic and extrinsic parameters of a camera, but also successfully corrects radial distortion of the camera, particularly demonstrating superior performance in environments where the radial distortion is pronounced. Analysis of the average reprojection errors shows that an improved calibration algorithm based on the intelligent optimization algorithm has improved the accuracy of the calibration results compared with Zhang's camera calibration method and the MATLAB toolbox in a case of significant camera distortion. Specifically, among three calibration optimization algorithms, an average reprojection error of the IDDE-PSO algorithm provided by the disclosure is reduced by 0.1658 pixels compared with the traditional PSO calibration method and 0.1804 pixels compared with the QPSO method. Compared with the MATLAB toolbox, the accuracy of the calibration results of the IDDE-PSO algorithm provided by the disclosure is improved by about 53%. Compared with Zhang's camera calibration method, the accuracy of the calibration results of the IDDE-PSO algorithm provided by the disclosure is improved by 56%. This remarkable advantage fully proves the effectiveness of the IDDE-PSO algorithm for camera intrinsic parameter calibration provided by the disclosure on improving the accuracy of the calibration results.

The aforementioned description of the embodiments of the disclosure is used to enable those skilled in the art to realize or use the disclosure. Various modifications of these embodiments are apparent to those skilled in the art. Principles defined herein can be implemented in other embodiments without departing from spirits or a scope of protection of the disclosure. Therefore, the disclosure is not limited to these embodiments described herein, but will conform to a widest scope consistent with the principles and novel features disclosed herein.

1. A camera calibration method based on an integrated dynamic dispersion-enhanced particle swarm optimization (IDDE-PSO) algorithm, comprising the following steps:
S1, acquiring a plurality of images of a calibration board of different angles, converting the plurality of images of the calibration board into grayscale images, detecting Harris corner points of the grayscale images, and solving sub-pixel coordinates;
S2, estimating, by using the sub-pixel coordinates and a distortion camera model, initial values X₀ of camera intrinsic parameters through Zhang's camera calibration method;
S3, initializing parameters of the IDDE-PSO algorithm, calibrating the camera intrinsic parameters based on the initial values of the camera intrinsic parameters, and calculating fitness values of particles;
S4, determining whether the fitness values of the particles have reached a convergence condition; when the fitness values of the particles have not reached the convergence condition, performing adaptive nonlinear adjustment on an inertial parameter, adaptively adjusting learning factors by using sine and cosine variations, iteratively updating velocities and positions of the particles, continuously updating individual optimal positions and global optimal positions of the particles by using a greedy selection algorithm, optimizing the camera intrinsic parameters by using the IDDE-PSO algorithm, and determining whether a maximum number of iterations is reached or a specific fitness threshold is met;
S5, determining whether the IDDE-PSO algorithm is trapped in a local optimum when the fitness values of the particles in step S4 have reached the convergence condition; when the IDDE-PSO algorithm is trapped in the local optimum, introducing a Cauchy perturbation-based particle swarm optimization algorithm, updating the individual optimal positions of the particles and re-evaluating the fitness values of the particles, continuously updating the individual optimal positions and the global optimal positions of the particles by using the greedy selection algorithm, optimizing the camera intrinsic parameters by using the IDDE-PSO algorithm, and determining whether the maximum number of iterations is reached or the specific fitness threshold is met; when the IDDE-PSO algorithm is not trapped in the local optimum, directly determining whether the maximum number of iterations is reached or the specific fitness threshold is met; and
S6, outputting camera parameters corresponding to a global optimal solution of the particles, when the maximum number of iterations is reached or the specific fitness threshold is met; returning to execute steps S3 to S5 until the maximum number of iterations is reached or the specific fitness threshold is met, when the maximum number of iterations is not reached and the specific fitness threshold is not met.

2. The camera calibration method based on the IDDE-PSO algorithm as claimed in claim 1, wherein, in step S2, the initial values X₀ of the camera intrinsic parameters estimated through the Zhang's camera calibration method are specifically as follows:
$${X}_{0} = ( α , β , γ , {u}_{0} , {v}_{0} , {k}_{1} , {k}_{2} , {p}_{1} , {p}_{2} , {k}_{3} ) ;$$
where, (u₀, v₀) is a principal point coordinate of image; (α,β) is a ratio of a camera focal length to a physical size of a unit pixel; γ represents a skew factor, k₁, k₂, and k₃ are radial distortion parameters, and p₁ and p₂ are tangential distortion parameters.

3. The camera calibration method based on the IDDE-PSO algorithm as claimed in claim 1, wherein the parameters of the IDDE-PSO algorithm initialized in step S3 comprise a population size N, the maximum number of iterations T, a stagnation threshold Sₜ=15, an inertia weight w, and maximum values and minimum values of the learning factors c₁ and c₂.

4. The camera calibration method based on the IDDE-PSO algorithm as claimed in claim 1, wherein, in step S3, the calculating fitness values of particles specifically comprises:
calculating a minimum average reprojection error X_{best} of M corner points in each of the plurality of images of the calibration board, and taking the minimum average reprojection error X_{best} as an optimization objective;
taking current position of each of the particles as the individual optimal position of the particle; and
taking the fitness value of current one of the particles as an individual optimal solution of the current one of the particles.

5. The camera calibration method based on the IDDE-PSO algorithm as claimed in claim 4, wherein the calculating a minimum average reprojection error X_{best} of M corner points in each of the plurality of images of the calibration board is specifically as follows:
expressing an average reprojection error function of each of the plurality of images of the calibration board as follows:
$$f ( X ) = \frac{1}{M} \sqrt{{\sum }_{i = 1}^{M} {( K ( X ) [ R T ] {P}_{i} - {q}_{i} )}^{2}} ,$$
where, M is a number of corner points of the calibration board, K(X)[R T]Pᵢ is a coordinate of a reprojection point obtained by projecting a coordinate point Pᵢ in a world coordinate system corresponding to an i-th target point back onto an image plane through a nonlinear camera imaging model; and qᵢ is a sub-pixel corner point coordinate actually detected at an i-th corner point; and
calculating the minimum average reprojection error X_{best} of the M corner points in each of the plurality of images of the calibration board as follows:
$${X}_{best} = {arg min}_{x} ( \frac{1}{M} \sqrt{{\sum }_{i = 1}^{M} {( K ( X ) [ R T ] {P}_{i} - {q}_{i} )}^{2}} ) .$$

6. The camera calibration method based on the IDDE-PSO algorithm as claimed in claim 1, wherein in step S5, the Cauchy perturbation-based particle swarm optimization algorithm is specifically as follows:
$$\{ \begin{matrix}{v}_{id}^{t + 1} = {w}_{id}^{t} {v}_{id}^{t} + {c}_{1} {r}_{1} ( {p}_{id}^{t} - {X}_{id}^{t} + {r}_{3} {Gaussian}_{i}^{t} ) + {c}_{2} {r}_{2} ( {g}_{d} - {X}_{id}^{t} ) \\ {x}_{id}^{t + 1} = {x}_{id}^{t} + {v}_{id}^{t + 1}\end{matrix}$$
$$where {Cauchy}_{i}^{t} = {r}_{4} Cauchy ( u , σ )$$
represents a Cauchy perturbation generated by a particle i in a t-th iteration; u represents a mean value, r₃ and r₄ are random numbers in a range of
$$[ 0 , 1 ] ; σ = {σ}_{0} \frac{T - t}{T}$$
represents a variance; σ₀ represents an initial standard deviation; t represents a current number of iterations; and T represents the maximum number of iterations.

7. The camera calibration method based on the IDDE-PSO algorithm as claimed in claim 1, wherein in step S4, the performing adaptive nonlinear adjustment on an inertia parameter is realized as follows:
$${w}_{i}^{t} = \{ \begin{matrix}{w}_{min} - ( {w}_{max} - {w}_{min} ) \frac{f ( {X}_{i}^{t} ) - {f}_{min}^{t}}{{f}_{average}^{t} - {f}_{min}^{t}} , f ( {X}_{i}^{t} ) \leq {f}_{average}^{t} \\ {w}_{max} , f ( {X}_{i}^{t} ) > {f}_{average}^{t}\end{matrix}$$
$${f}_{average}^{t} = \frac{{\sum }_{i = 1}^{n} f ( {X}_{i}^{t} )}{n}$$
$${f}_{min}^{t} = min \{ f ( {X}_{1}^{t} ) , f ( {X}_{2}^{t} ) , … , f ( {X}_{n}^{t} ) \}$$
where, wₘₐₓ=0.9 represents a maximum value of the inertial parameter; wₘᵢₙ=0.4 represents a minimum value of the inertial parameter;
$$f ( {X}_{i}^{t} )$$
represents the fitness value of current one of the particles in a t-th iteration;
$${f}_{average}^{t}$$
represents an average value of current fitness values of all the particles; and
$${f}_{min}^{t}$$
represents a minimum value of the current fitness values of all the particles.

8. The camera calibration method based on the IDDE-PSO algorithm as claimed in claim 1, wherein, in step S4, the adaptively adjusting learning factors by using sine and cosine variations is realized as follows:
$${c}_{1} = {c}_{1 \_ max} + ( {c}_{1 \_ max} - {c}_{1 \_ min} ) cos ( π * \frac{t}{T} )$$
$${c}_{2} = {c}_{2 \_ max} + ( {c}_{2 \_ max} - {c}_{2 \_ min} ) sin ( π * \frac{t}{T} )$$
where, c_{1_max}=1.5 and c_{1_min}=1 are upper and lower limit values of a learning factor c₁, respectively; c_{2_max}=1.5 and c_{2_min}=1 are upper and lower limit values of a learning factor c₂, respectively; t represents a current number of iterations; and T represents a total number of iterations.

9. The camera calibration method based on the IDDE-PSO algorithm as claimed in claim 1, wherein, in step S4, the iteratively updating velocities and positions of the particles specifically comprises the following steps:
taking positions corresponding to all the particles as global optimal positions;
comparing a current state of each of the particles with a historical global optimal state of the particle, screening by minimizing an average reprojection error function, and taking current fitness value of the particle and a position of the particle corresponding thereto as an updated individual optimal value of the particle when the current fitness value of the particle is smaller than an individual optimal value of the particle; and
calculating a minimum value of individual optimal values of all the particles; comparing the minimum value with a global optimal value; and when the minimum value is smaller than the global optimal value, namely a particle state is better than a global optimal state, updating the global optimal state.

10. The camera calibration method based on the IDDE-PSO algorithm as claimed in claim 1, wherein, in step S5, the updating the individual optimal positions of the particles and re-evaluating the fitness values of the particles is realized as follows:
$${v}_{id}^{t + 1} = {wv}_{id}^{t} + {c}_{1} {r}_{1} ( {p}_{id}^{t} - {X}_{id}^{t} ) + {c}_{2} {r}_{2} ( {g}_{d} - {X}_{id}^{t} )$$
$${X}_{id}^{t + 1} = {X}_{id}^{t} + {v}_{id}^{t + 1} , d = 1 , 2 , … , D$$
$$where , {v}_{id}^{t}$$
represents the velocity of a particle; a superscript t represents a current number of iterations; a subscript i represents an index of the particle; a subscript d represents a dimension of the particle; X represents a position of an i-th particle; p represents the individual optimal position P_{best} of the i-th particle; g represents a global optimal value searched by a particle swarm; w represents an inertia weight and is configured to balance global search and local development capabilities; c₁ and c₂ are acceleration coefficients, namely the learning factors; and r₁ and r₂ are random numbers in a range of [0, 1].
